(19) United States
(12) Patent Application Publication
(10) Pub. No.: US 2023/0359977 A1
(43) Pub. Date: Nov. 9, 2023

(54) OPTIMIZED DYNAMIC SCHEDULING OF BARGES IN INLAND WATERWAYS

(71) Applicant: Inlecom Group BV, Bruxelles (BE)

(72) Inventors: Konstantinos ZAVITSAS, London (GB); Verlee Leemen, Antwerp (BE); Panayotis Katsoulakos, Haywards Heath (GB); Patrick J. O'Sullivan, Dublin (IE)

(73) Assignee: Inlecom Group BV, Bruxelles (BE)

(21) Appl. No.: 17/735,437

(22) Filed: May 3, 2022

(51) Int. Cl. G06Q 10/08; G06Q 10/04; G06Q 10/06; H04W 4/02; H04W 4/38; H04W 4/40

(52) U.S. Cl. CPC G06Q 10/083; G06Q 10/047; G06Q 10/06315; H04W 4/025; H04W 4/38; H04W 4/40

(57) ABSTRACT

The optimized dynamic scheduling of barges in inland waterways includes geolocating a set of barges positioned on an inland waterway and receiving current data for the inland waterway at each geolocation of each barge in the set. An estimated time of arrival (ETA) for each barge is retrieved from a table at a location for each barge along the inland waterway at which point the barge unloads onboard freight rendering the barge available to receive transport of new freight. Each ETA is modified for each barge according to the received current data at multiple different positions along a route in the inland waterway. Finally, an availability table for the barges in the set is constructed based upon each modified ETA so that barge availability queries received from over a computer communications network can be responded to with availability information stored in the availability table.

### BACKGROUND OF THE INVENTION

### Field of the Invention

The present invention relates to the technical field of inland waterway barge scheduling.

### Description of the Related Art

In supply chain logistics, the notion of water transport generally conjures imagery of an ocean-going vessel. However, in many regions of the world, water transport refers to the use of an inland waterway as a transport path alternative to road, rail or airborne freight movement. Road transport relies upon the truck as the primary mode of transport, rail transport relies upon the locomotive driven train as the mode of transport, and air transport relies upon the airplane as the mode of transport. However, in the inland waterway context, the barge is the typical mode of transport. Unlike road, rail and air transport, though, in the inland waterway context, carbon emissions are dramatically less given the lower vessel speeds, a lack of uphill and downhill movements and the opportunity to utilize battery powered electric motors to propel the barge along the inland waterway. Hence, from simply a perspective of carbon emissions, scheduling freight transport by way of an inland waterway is highly desirable.

The inland waterway as a path of transport differs from road, rail and airborne transport in many ways. First and foremost, when utilizing the inland waterway as a path of transport, the path of the inland waterway itself is largely the result of natural consequence and not man-made choice. The network of available paths to a desired destination can be less robust than the traditional road network and far less robust than the routing available in air transport. Like the railway system, there are only so many paths to a destination. But, unlike the railway system, external natural factors affect the ability to move a barge from one location in an inland waterway to another.

In this regard, the condition of the rail itself is generally a constant. The resistive forces to the forward movement of a train are negligible. So long as there is not an anomalous event such as an unexpected obstruction like a fallen tree or a blocking vehicle at a railroad crossing, it can be presumed that the rail remains passable for a train at all times with an identical condition. In contrast, with respect to an inland waterway, currents vary and can act as a substantial resistive force to the forward movement of a barge. The depth of the inland waterway can vary according to natural events such as rain and drought along with tide. Hence the passibility of a portion of the inland waterway can vary widely.

Because of the unique nature of the inland waterway, oftentimes the use of the inland waterway is overlooked for more predictable routes of transport. Indeed, in order to predict the progress of any particular barge navigating an inland waterway, one is reliant upon the stated estimated time of arrival of a barge operator. However, those who require accurate predictability of the expected time of arrival of a barge are left disappointed by the absence of real time, geographically precise data as to waterway current and depth which necessarily affects the stated estimated time of arrival of a barge within an inland waterway. Thus, scheduling the transport of freight over the inland waterways has proven to be an inexact science which in turn makes the selection of inland waterways transport from booking platforms problematic.

### BRIEF SUMMARY OF THE INVENTION

Embodiments of the present invention address technical deficiencies of the art in respect to the scheduling of freight transport over inland waterways. To that end, embodiments of the present invention provide for a novel and non-obvious method for optimized dynamic scheduling of barges in inland waterways including the specification of a dataset to be available for use by synchromodal transport booking platforms. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method including a blockchain application programming interface (API) to enable integration in booking platforms.

In one embodiment of the invention, a method for optimized dynamic scheduling of barges in inland waterways includes geolocating a set of barges positioned on an inland waterway and then receiving current data for the inland waterway at each geolocation of each of the barges in the set. The method further includes retrieving from a table an estimated time of arrival (ETA) for each corresponding one of the barges at a location for each corresponding one of the barges along the inland waterway at which point each corresponding one of the barges unloads onboard freight rendering the corresponding one of the barges available to receive transport of new freight. The ETA of each corresponding one of the barges is then modified according to the received current data at multiple different positions along a route in the inland waterway for the corresponding one of the barges moving towards the location at which point the corresponding one of the barges unloads the onboard freight. Finally, an availability table for the barges in the set is constructed based upon the modified ETA of each corresponding one of the barges so that barge availability queries received from over a computer communications network can be responded to with availability information stored in the availability table.

In one aspect of the embodiment, the current data is received from each corresponding one of the barges from a flow sensor affixed to the corresponding one of the barges. Alternatively, the current data is received from each corresponding one of the barges as a function of power input to engines powering the corresponding one of the barges at the geolocation and an actual speed of the corresponding one of the barges at the geolocation. In another aspect of the embodiment, the current data also includes a depth of the inland waterway at the geolocation. In this way, the ETA is modified to account for the depth of the inland waterway at each of the multiple locations and a draft of each of the barges thereby determining navigability of the inland waterway for each corresponding one of the barges.

In another embodiment of the invention, a data processing system is adapted for optimized dynamic scheduling of barges in inland waterways. The system includes a host computing platform of one or more computers, each with memory and one or processing units including one or more processing cores. A scheduling module includes computer program instructions which execute in the memory of one or more of the processing units, which instructions are enabled during execution to geolocate a set of barges positioned on an inland waterway and to receive current data for the inland waterway at each geolocation of each of the barges in the set. The instructions further are enabled to retrieve from a table an ETA for each corresponding one of the barges at a location for each corresponding one of the barges along the inland waterway at which point each corresponding one of the barges unloads onboard freight rendering the corresponding one of the barges available to receive transport of new freight.

The program instructions yet further are enabled to modify the ETA of each corresponding one of the barges according to the received current data at multiple different positions along a route in the inland waterway for the corresponding one of the barges moving towards the location at which point the corresponding one of the barges unloads the onboard freight. Finally, the program instructions are enabled to construct an availability table for the barges in the set based upon the modified ETA of each corresponding one of the barges and to respond to barge availability queries from over a computer communications network with availability information stored in the availability table. In this way, the technical deficiencies of the scheduling of barges in an inland waterway are overcome owing to incorporation of real-time geolocated current and depth information in an ETA for each of the barges in the inland waterway while removing the subjective guesswork of a stated ETA by the individual operators of barges.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of optimized dynamic scheduling of barges in inland waterways;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for optimized dynamic scheduling of barges in an inland waterway. In accordance with an embodiment of the invention, different barges navigating an inland waterway whilst transporting freight report current and positioning data so that the current conditions can be determined throughout a route on the inland waterway. As such, a real time barge availability table can be maintained for each of the different barges, the table tracking an ETA for each barge accounting for a contemporaneously known position of each barge in the inland waterway, the current expected at each segment along a route between the known position and a destination of the barge, as reported by others of the barges at the segments of the route, and the expected speed achievable by the barge given the current. Consequently, the table responsive to a query can report with accuracy a likely ETA for each of the barges in order to identify one of the barges most likely to be able to accommodate the transport of new freight at a particular loading point of the inland waterway.

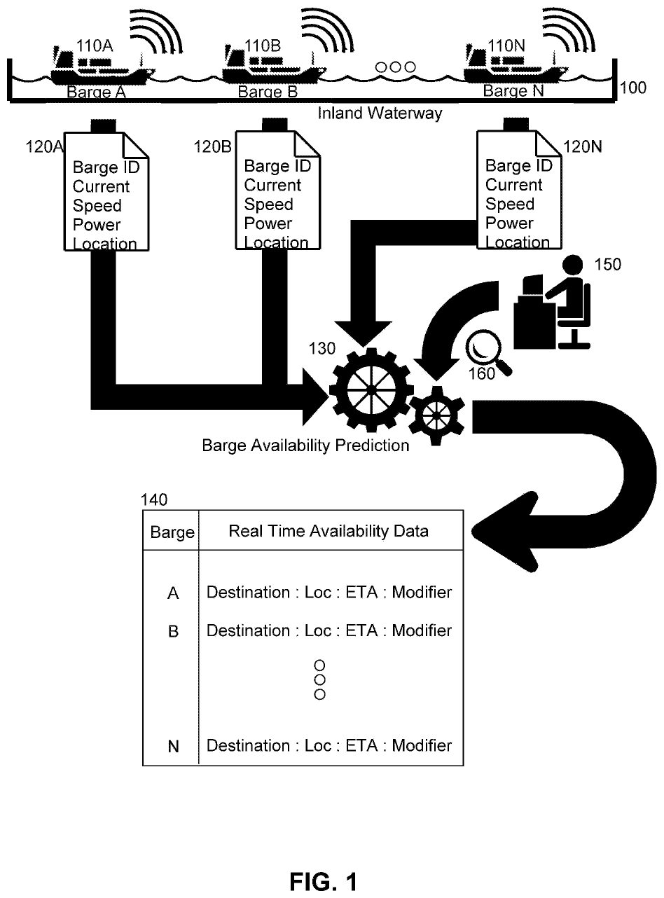

In illustration of one aspect of the embodiment, FIG. 1 pictorially shows a process of optimized dynamic scheduling of barges in inland waterways. As shown in FIG. 1, different barges 110A, 110B, 110N navigate a route along an inland waterway 100. Each of the barges 110A, 110B, 110N wirelessly transmits corresponding messages 120A, 120B, 120N to barge availability prediction logic 130, each of the messages 120A, 120B, 120N providing an identifier of a corresponding one of the barges 110A, 110B, 110N, a geolocation of a corresponding one of the barges 110A, 110B, 110N, a waterway current measured at the geolocation of the corresponding one of the barges 110A, 110B, 110N, a speed of the corresponding one of the barges 110A, 110B, 110N and a power applied to the motor of the corresponding one of the barges 110A, 110B, 110N. Optionally, a depth of the inland waterway 100 at the geolocation of the corresponding one of the barges 110A, 110B, 110N as measured by the corresponding one of the barges 110A, 110B, 110N can be included as can a vessel draught.

The barge availability prediction logic 130 in receiving the messages 120A, 120B, 120N develops an awareness of the contemporaneous current conditions at different geolocations along the inland waterway 100. Given the awareness of the contemporaneous current conditions, the barge availability prediction logic 130 modifies a stated ETA within a table 140 for each corresponding one of the barges 110A, 110B, 110N. The logic 130 modifies the ETA by determining a set of route segments along a route from the geolocation of the corresponding one of the barges 110A, 110B, 110N and a known destination of the corresponding one of the barges 110A, 110B, 110N, computing a transit time along each of the segments reducing the desired speed of the corresponding one of the barges 110A, 110B, 110N resulting from an associated measurement of current at each of the segments, and summing the transit time for each of the segments. The difference between the stated ETA and the sum of transit times from a current time thus produces a modifier to the stated ETA.

In that the barge availability prediction logic 130 maintains the table 140 of real time availability data for each of the barges 110A, 110B, 110N, a query interface 160 is provided to the table 140 permitting an external booker 150 to accurately select one of the barges 110A, 110B, 110N to transport freight based upon a realistic ETA computed for the selected one of the barges 110A, 110B, 110N as opposed to a merely stated ETA for the selected one of the barges 110A, 110B, 110N.

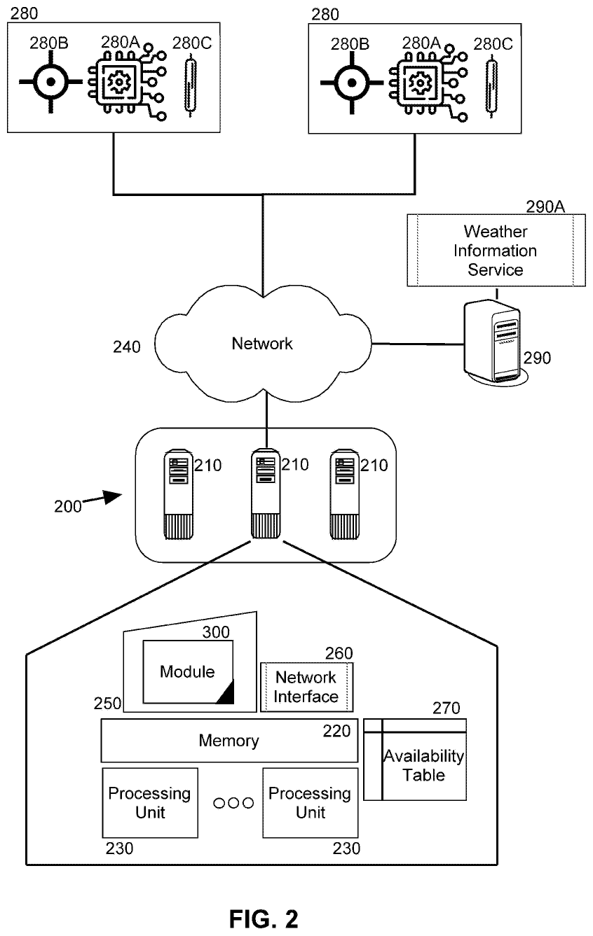

Aspects of the process described in connection with FIG. 1 can be implemented within a data processing system. In further illustration, FIG. 2 schematically shows a data processing system adapted to perform optimized dynamic scheduling of barges in inland waterways. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers 210 can be remotely disposed from one another and in communication with one another through network interface 260 over a data communications network 240.

Different computing clients 280 communicate with the host computing platform 200 over the data communications network 240. The different computing clients 280 are mounted on different barges navigating an inland waterway and include a processor 280A, global positioning circuitry 280B and one or more sensors 280C including a current sensor and a depth sensor able to determine a depth of a waterway relative to a draught of the vessel. Optionally, a weather information service 290A accessible through a remote server 290 communicates with the host computing platform 200 over the data communications network 240 and provides current weather information such as wind speed and direction for a specified geolocation.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for optimized dynamic scheduling of barges in inland waterways. Specifically, the program instructions during execution receive from the global positioning circuitry 280B of each of the computing clients 280, a contemporaneous geolocation of a corresponding barge. As well, the program instructions during execution receive from the sensors 280C both a depth reading of the inland waterway at the contemporaneous geolocation of the barge, and also a current vector indicating speed and direction of the current at the contemporaneous geolocation. Optionally, the current vector can be computed based upon an expected speed given a power setting of the motor powering the barge and an expected heading and actual heading of the barge.

Upon receipt of the geolocation, depth and current information, the program instructions compute a modified ETA for the barge and store the modified ETA in an availability table 270 stored in the memory 220. In this regard, the program instructions determine a route from the geolocation of the barge to a known destination of the barge along the inland waterway. The program instructions then query the availability table 270 in order to identify all current values along the route, each of the values defining a segment of the route. The program instructions given the current values for each of the segments along the route then computes a transit time expected for the barge given the power setting of the barge, the expected speed of the barge and the actual speed expected to result in light of the current at a corresponding one of the segments. The program instructions further query the weather information service 290A in order to retrieve wind speed information for each of the segments and account for wind speed and direction when computing the transit time for a particular one of the segments.

The program instructions then sum the transit time for each segment to produce a total transit time which when added to a contemporaneous time, results in a modified ETA which the program instructions then write to the availability table 270. As such, the program instructions support queries to the availability table 270 to identify a barge at a docking location along the inland waterway most likely to be present at a particular time when the barge can receive new freight for transport. As well, the likely ETA of the new freight at a different docking location along the inland waterway can be determined in the same manner. Even further, the availability table can store an available additional weight able to be stored on the barge based upon a current weight of the barge determined in real time based upon a known draught of the barge and a sensed distance between the keel of the barge and a bottom of the wateray.

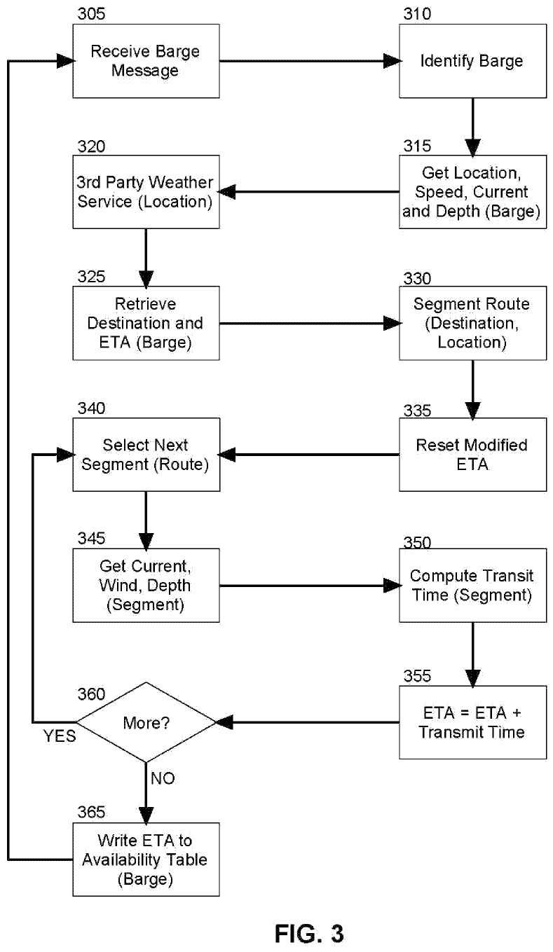

In further illustration of an exemplary operation of the module, FIG. 3 is a flow chart illustrating one of the aspects of the process of FIG. 1. Beginning in block 305, a barge message is received which includes an identity of the barge, a geolocation of the barge, a speed of the barge, a current measurement of the waterway at the geolocation and a depth of the waterway at the geolocation. In block 310, the barge is identified from the message and in block 315, each of the geolocation, speed, current and depth measurements are retrieved from the message. As well, in block 320, a third party weather information service is queried to retrieve wind speed and direction data for the geolocation.

In block 325, a destination and previously determined ETA is retrieved from an availability table in connection with the identified barge. Then, in block 330 the route between the geolocation of the barge and the destination of the barge is determined as a set of segments, each of the segments corresponding to previously received current and wind information along the route. In block 335, a modified ETA is reset to zero and in block 340, a first segment in the route is selected for processing. In block 345 the wind speed and direction, current speed and direction and water depth is retrieved for the segment. In block 350, the anticipated transit time of the barge to traverse the segment is computed based upon a desired speed in light of the current speed and direction, wind speed and direction and the depth of the waterway at the segment relative to the known draft of the barge.

In this regard, it is to be recognized that the transit time can be shorter than expected owing to a greater speed than directed resulting from a trailing wind or trailing current. Conversely, the transit time can be longer than expected owing to a slower speed than directed resulting from a headwind or opposing current. Of course, to the extent that the depth of a segment does not permit or inhibits passage of the barge through the segment, the transmit time will increase pending an expected rising water level at a later time.

In block 355, the computed transit time is added to the modified ETA value and the current time to produce a new modified ETA value and in decision block 360, if additional segments remain to be processed, the flow returns to block 340 with the selection of the next segment along the route. The flow then continues for the next segment with the computation of the transit time for the next segment in block 350 and the addition of the transmit time to the transmit time computed for the previous segments. In decision block 360, when no further segments along the route remain to be processed, in block 365 the modified ETA is written to the availability table for the barge.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for optimized dynamic scheduling of barges in inland waterways comprising:
geolocating a set of barges positioned on an inland waterway;
receiving current data for the inland waterway at each geolocation of each of the barges in the set;
retrieving from a table an estimated time of arrival (ETA) for each corresponding one of the barges at a location for each corresponding one of the barges along the inland waterway at which point each corresponding one of the barges unloads onboard freight rendering the corresponding one of the barges available to receive transport of new freight;
modifying the ETA of each corresponding one of the barges according to the received current data at multiple different positions along a route in the inland waterway for the corresponding one of the barges moving towards the location at which point the corresponding one of the barges unloads the onboard freight;
constructing an availability table for the barges in the set based upon the modified ETA of each corresponding one of the barges; and,
responding to barge availability queries from over a computer communications network with availability information stored in the availability table.

2. The method of claim 1, wherein the current data is received from each corresponding one of the barges from a flow sensor affixed to the corresponding one of the barges.

3. The method of claim 1, wherein the current data is received from each corresponding one of the barges as a function of power input to engines powering the corresponding one of the barges at the geolocation and an actual speed of the corresponding one of the barges at the geolocation.

4. The method of claim 1, wherein the current data also includes a depth of the inland waterway at the geolocation, the ETA being modified to account for the depth of the inland waterway at each of the multiple locations and a draft of each of the barges thereby determining navigability of the inland waterway for each corresponding one of the barges.

5. A data processing system adapted for optimized dynamic scheduling of barges in inland waterways, the system comprising:
a host computing platform comprising one or more computers, each with memory and one or processing units including one or more processing cores; and,
a scheduling module comprising computer program instructions enabled while executing in the memory of at least one of the processing units of the host computing platform to perform:
geolocating a set of barges positioned on an inland waterway;
receiving current data for the inland waterway at each geolocation of each of the barges in the set;
retrieving from a table an estimated time of arrival (ETA) for each corresponding one of the barges at a location for each corresponding one of the barges along the inland waterway at which point each corresponding one of the barges unloads onboard freight rendering the corresponding one of the barges available to receive transport of new freight;
modifying the ETA of each corresponding one of the barges according to the received current data at multiple different positions along a route in the inland waterway for the corresponding one of the barges moving towards the location at which point the corresponding one of the barges unloads the onboard freight;
constructing an availability table for the barges in the set based upon the modified ETA of each corresponding one of the barges; and,
responding to barge availability queries from over a computer communications network with availability information stored in the availability table.

6. The system of claim 5, wherein the current data is received from each corresponding one of the barges from a flow sensor affixed to the corresponding one of the barges.

7. The system of claim 5, wherein the current data is received from each corresponding one of the barges as a function of power input to engines powering the corresponding one of the barges at the geolocation and an actual speed of the corresponding one of the barges at the geolocation.

8. The system of claim 5, wherein the current data also includes a depth of the inland waterway at the geolocation, the ETA being modified to account for the depth of the inland waterway at each of the multiple locations and a draft of each of the barges thereby determining navigability of the inland waterway for each corresponding one of the barges.

9. A computing device comprising a non-transitory computer readable storage medium having program instructions stored therein, the instructions being executable by at least one processing core of a processing unit to cause the processing unit to perform a method for optimized dynamic scheduling of barges in inland waterways, the method including:
geolocating a set of barges positioned on an inland waterway;
receiving current data for the inland waterway at each geolocation of each of the barges in the set;
retrieving from a table an estimated time of arrival (ETA) for each corresponding one of the barges at a location for each corresponding one of the barges along the inland waterway at which point each corresponding one of the barges unloads onboard freight rendering the corresponding one of the barges available to receive transport of new freight;
modifying the ETA of each corresponding one of the barges according to the received current data at multiple different positions along a route in the inland waterway for the corresponding one of the barges moving towards the location at which point the corresponding one of the barges unloads the onboard freight;
constructing an availability table for the barges in the set based upon the modified ETA of each corresponding one of the barges; and,
responding to barge availability queries from over a computer communications network with availability information stored in the availability table.

10. The device of claim 9, wherein the current data is received from each corresponding one of the barges from a flow sensor affixed to the corresponding one of the barges.

11. The device of claim 9, wherein the current data is received from each corresponding one of the barges as a function of power input to engines powering the corresponding one of the barges at the geolocation and an actual speed of the corresponding one of the barges at the geolocation.

12. The device of claim 9, wherein the current data also includes a depth of the inland waterway at the geolocation, the ETA being modified to account for the depth of the inland waterway at each of the multiple locations and a draft of each of the barges thereby determining navigability of the inland waterway for each corresponding one of the barges.
